(19) United States
(12) Patent Application Publication
(10) Pub. No.: US 2024/0378592 A1
(43) Pub. Date: Nov. 14, 2024

(54) SYSTEM AND METHOD FOR DIGITAL CRYPTO TREASURE HUNT USING CRYPTOGRAPHICALLY SECURED ASSETS AND CRYPTOCURRENCY WALLET SEED PHRASES WITHIN ELECTRONIC ART

(71) Applicant: Jon Nelson Andresen, JR., Thornton, CO (US)

(72) Inventor: Jon Nelson Andresen, JR., Thornton, CO (US)

(21) Appl. No.: 18/144,856

(22) Filed: May 9, 2023

(51) Int. Cl. G06Q 20/36; G06Q 20/38; G07F 17/32

(52) U.S. Cl. CPC G06Q 20/3672; G06Q 20/3825; G06Q 20/389; G07F 17/3237; G07F 17/3286

(57) ABSTRACT

A means for owner(s)/creator(s) to set up various cryptocurrency wallets and create and sell electronic art in the form of a non-fungible token (NFT) in the creation of a digital crypto treasure hunting game. The premise of the invention is to incorporate hidden clues within the electronic art that allow a player to determine the words, number of words, and order of the words of the seed phrases of a treasure wallet, which will contain a portion of the proceeds from the sale and resale of the NFTs. Once a player purchases an NFT, determines the seed phrases, and correctly enters in the seed phrases into a new game wallet, then the player will have access to any or all of the cryptocurrency that was in the treasure wallet and can move it to make it accessible only to them and inaccessible to other players.

### RELATED APPLICATION

The present application is a continuation-in-part application of United States provisional patent application, application No. 63/462,249, EFS ID number 47910419, filed Apr. 27, 2023, for SYSTEM AND METHOD FOR DIGITAL CRYPTO TREASURE HUNT USING CRYPTOGRAPHICALLY SECURED ASSETS AND CRYPTOCURRENCY WALLET SEED PHRASES WITHIN ELECTRONIC ART, by Jon Nelson Andresen Jr., included by reference herein and for which benefit of the priority date is hereby claimed.

### FIELD OF THE INVENTION

The present invention relates to the use of cryptographic assets secured in unison with cryptocurrency wallet seed phrases to create a digital treasure hunt, and, more particularly, to have the cryptographic asset secured with crypto smart contracts and minted or tokenized and deployed on a distributed ledger (blockchain) to work in unison with seed phrases of cryptocurrency treasure wallets as part of the digital clues of the of cryptographic asset. Furthermore, the smart contract shall have portions of the sale and resale of the token distributed to the cryptocurrency treasure wallets the users are hunting for in the digital crypto treasure hunt.

### BACKGROUND OF THE INVENTION

There is not a game or means where electronic art is created using seed phrases from a cryptocurrency treasure wallet as clues within the art that is then used as the basis for the digital crypto treasure hunt. Several previously patented cryptocurrency and cryptographic systems are used to form the framework of the game with a key component of the game being the incorporation of seed phrases of a treasure wallet into the electronic art as clues. This is achieved when the owner(s)/creator(s) set up a cryptocurrency treasure wallet, generating seed phrases for that wallet. The owner(s)/creator(s) then use those seed phrases as clues in the creation of the electronic art. The electronic art and clues within that art can take many sensory forms, but will mainly consist of visual or auditory forms, like still images, clips, movies, songs, music, sounds and the like. The electronic art is then cryptographically secured by creating a non-fungible token (NFT) that ties the electronic art to a smart contract. The owner(s)/creator(s) can then market and sell that NFT on an NFT Marketplace, where the sale triggers the smart contract that allows the portions of the proceeds to be sent to the treasure wallet and portions of the proceeds to go to any other owner/creator wallets.

A player can use their own player wallet to interact with the NFT Marketplace to purchase NFTs that are associated with the game. The player would then study those NFTs to find the clues and determine the exact seed phrases of the treasure wallet. The game may require several NFTs to determine the full seed phrases of the treasure wallet, including the exact number of words and order of words of the seed phrases. The player can then set up a separate cryptocurrency game wallet using the guesses of the treasure wallet seed phrases to access the treasure wallet's cryptocurrency.

It would be advantageous to provide electronic art that hides clues within the electronic artwork as to the words, number of words, and order of the words of the seed phrases to a specific treasure cryptocurrency wallet or wallets.

It would also be advantageous to provide a crypto smart contract attached to the electronic art, hereby referred to as a non-fungible token (NFT), such that the sale and resale of the NFT activates the smart contract.

It would further be advantageous to provide a process and means, whether manually or within the smart contract, to send a portion of the proceeds from the sale and resale of the electronic art to a treasure wallet or wallets.

It would further be advantageous to provide a means for players, through electronic devices and the internet, to connect to a NFT Marketplace and purchase the electronic art or NFTs to determine the seed phrases and their correct order that matches up with the treasure wallet(s) seed phrases.

It would further be advantageous to provide a means for the player, through the use of electronic devices and the internet to set up a cryptocurrency wallet, hereafter called the game wallet, such that they may enter their guesses of the correct words, number of words, and order of words of the seed phrases that matches up with the treasure wallet(s) seed phrases.

It would further be advantageous to provide a means for the player to access the treasure wallet's cryptocurrency from the game wallet through entering in the correct words, number of words, and order of words of the seed phrases of the treasure wallet in the setup of the game wallet.

It would further be advantageous to provide a means for the player to then move any or all of the cryptocurrency within the game wallet to any other cryptocurrency wallet or cryptocurrency exchange.

It would further be advantageous to provide a means for the player to resell any previously purchased NFTs on the NFT Marketplace, the resale of which triggers the smart contract for resale and sends a portion of the proceeds to the play and the remainder to the owner/creator wallet(s) and treasure wallet(s).

### SUMMARY OF THE INVENTION

A means for owner(s)/creator(s) to set up various cryptocurrency wallets and create and sell electronic art in the form of a non-fungible token (NFT) in the creation of a digital crypto treasure hunting game. The premise of the game is to incorporate hidden clues within the electronic art that allows a player to determine the exact words, number of words, and order of the words of the seed phrases of a treasure wallet, which will contain a portion of the proceeds from the sale and resale of the electronic art. Once a player purchases an NFT, determines the seed phrases, and correctly enters in the exact seed phrases into a new game wallet, then they have access to any or all of the cryptocurrency that was in the treasure wallet and can move it to make it accessible only to them and inaccessible to other players.

### BRIEF DESCRIPTION OF DRAWINGS

A complete understanding of the present invention may be obtained by reference to the accompanying drawings, when considered in conjunction with the subsequent, detailed description, in which:

FIG. 1a is a diagram view of an embodiment of the process for creating a digital crypto treasure hunt by using the seed phrases of a treasure wallet within electronic art that is cryptographically secured as an NFT and sold to players on an NFT marketplace where the proceeds are sent to the owner/creator wallet(s) for distribution;

FIG. 1b is a diagram view of an embodiment of the process for creating a digital crypto treasure hunt by using the seed phrases of a treasure wallet within electronic art that is cryptographically secured as an NFT and sold to players on an NFT marketplace where the sale triggers a smart contract that automatically sends sale proceeds to the owner/creator wallet(s) and treasure wallet(s) based on the predefined smart contract percentages;

FIG. 1c is a diagram view of an embodiment of the process for creating a digital crypto treasure hunt by using the seed phrases of a treasure wallet within electronic art that is cryptographically secured as an NFT and sold to players on an NFT marketplace where the proceeds are sent to the treasure wallet(s) for distribution; and

FIG. 2 is a flow chart view of a process for a player to purchase an NFT to discover the clues of the seed phrases of the treasure wallet, then create a game cryptocurrency wallet using the seed phrases of the treasure wallet to gain access to the cryptocurrency treasure.

For purposes of clarity and brevity, like elements and components will bear the same designations and numbering throughout the Figures.

### DETAILED DESCRIPTION OF THE INVENTION

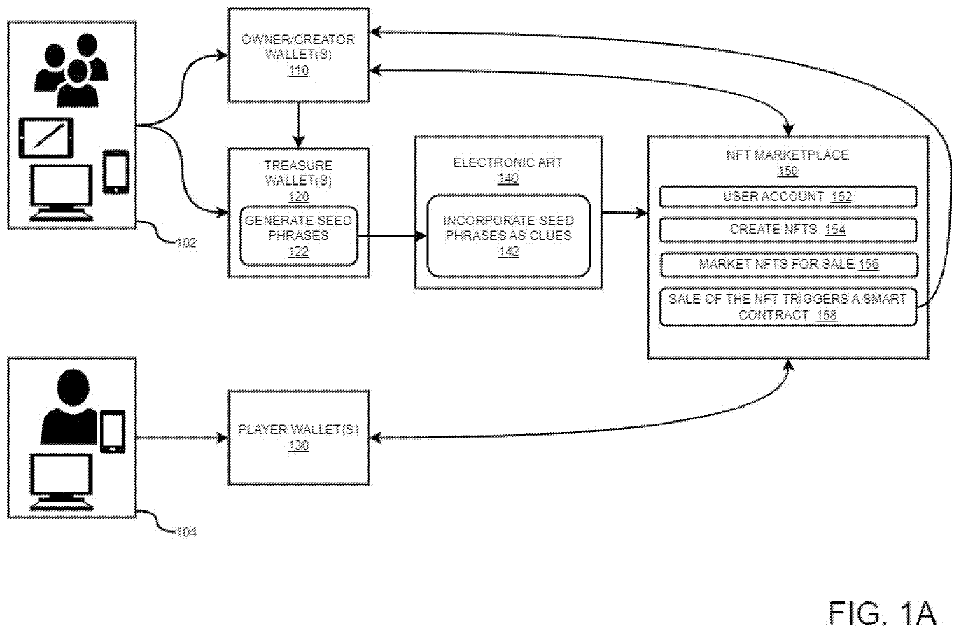

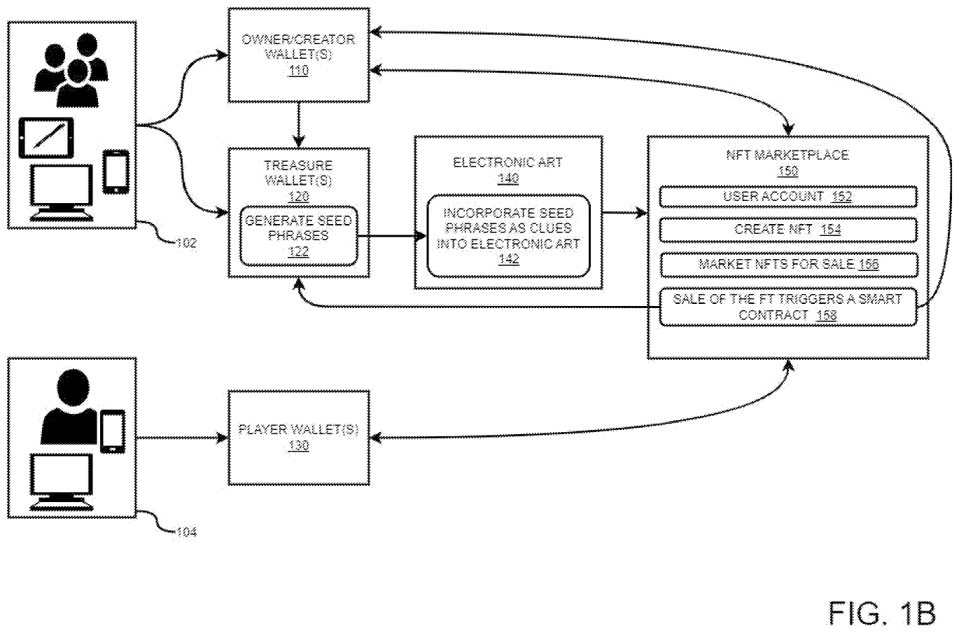

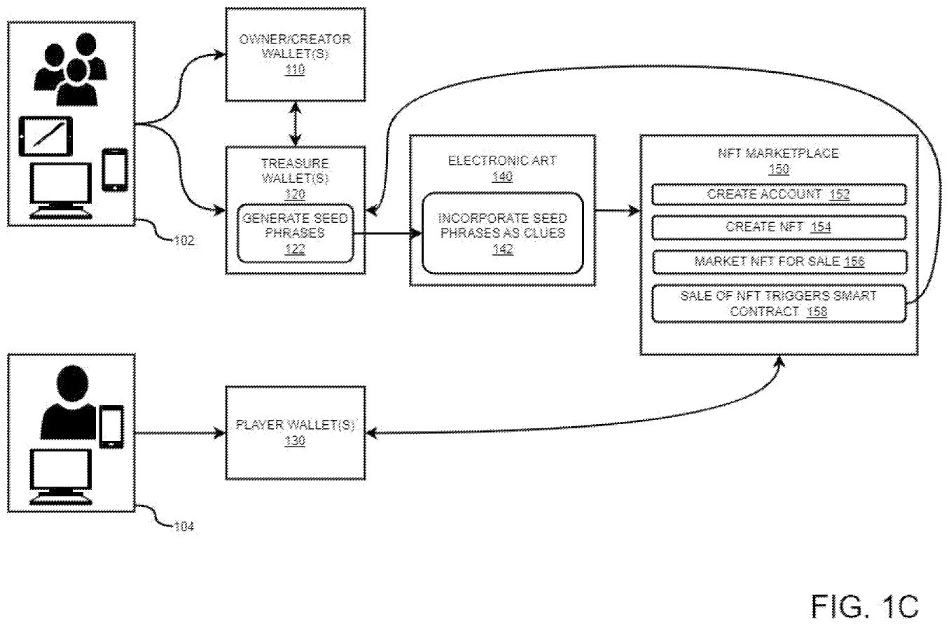

FIG. 1a is a diagram of an embodiment of the process for creating a digital crypto treasure hunt by using the seed phrases of a treasure wallet within electronic art 140 that is cryptographically secured as an NFT and sold to players on an NFT Marketplace 150 where the proceeds are sent to the owner/creator wallet(s) 110 for distribution.

There are two groups that make up the users of the digital crypto treasure hunt, the owner(s)/creator(s) 102 and the players. There may be one or more owner or creator, hereafter referred to as owner(s)/creator(s) 102, that use electronic devices, such as computers, electronic pads and mobile phones to complete the process of setting up owner/creator wallet(s) 110, treasure wallet(s) 120, create electronic art 140, covert electronic art 140 to a non-fungible token (NFT), and interact with a NFT Marketplace 150 to create a user account 152, create NFTs 154, and market NFTs for sale 156. A player 104 would use electronic devices, such as computers or mobile phones, to create their own player wallet(s) 130 that would be used to purchase NFTs created by the owner(s)/creator(s) 102 in the quest to win the cryptocurrency in the digital crypto treasure hunt. While this embodiment assumes a single player 104 in FIG. 1a, there could be multiple people that represent the player 104 as defined in this embodiment.

In this embodiment the owner(s)/creator(s) 102 set up a cryptocurrency wallet or wallets, hereafter referred to as the owner/creator wallet(s) 110, to be used for the sending and receiving of various cryptocurrencies for the activities associated with the creation of the digital crypto treasure hunt. For this embodiment the owner/creator wallet(s) 110 are used as the main cryptocurrency wallet connection and interface with the NFT Marketplace 150. The owner/creator wallet(s) 110, through the user account 152 in the NFT Marketplace 150, may then transfer cryptocurrency to pay for various fees in the creation, sale, resale, marketing, and minting of NFTs, along with paying of fees for other activities associated with the NFT Marketplace 150. The owner/creator wallet(s) 110 are also used to receive proceeds from the sale and resale of NFTs and then transfer a portion of the sale or resale proceeds to the treasure wallet(s) 120.

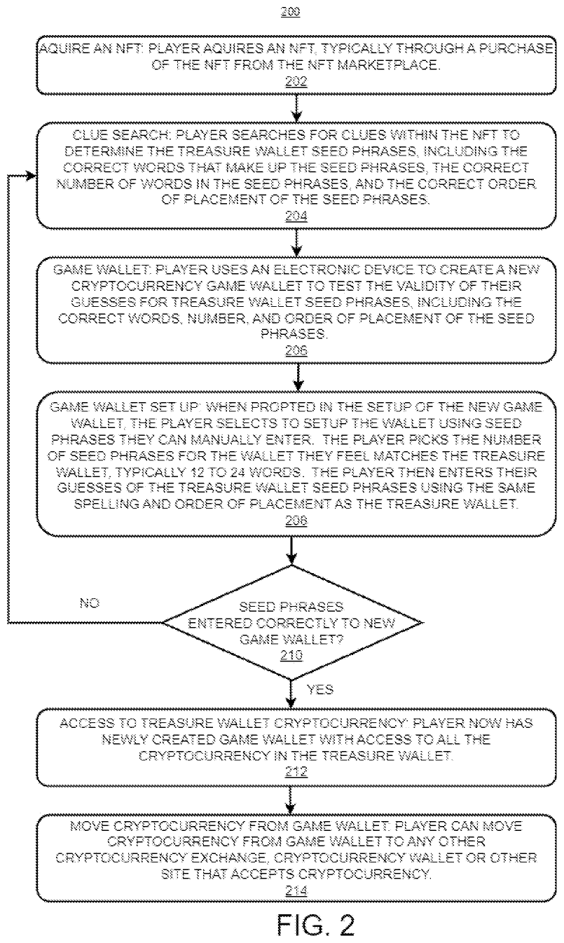

One of the main components of the digital crypto treasure hunt is for the owner(s)/creator(s) 102 to set up a cryptocurrency wallet or wallets, hereafter referred to as the treasure wallet(s) 120, where the setup of the wallet will generate seed phrases 122 which are then used by the owner(s)/creator(s) 102 to create electronic art 140 that are embedded with clues as to the seed phrases of the treasure wallet(s) 120. Another purpose of the treasure wallet(s) 120 is to receive a portion of the sale and resale proceeds of the electronic art 140 or NFT. A player 104 may then access the cryptocurrency within the treasure wallet(s) 120, as defined on the blockchain, if the player 104 is able to determine the seed phrases of the treasure wallet(s) 120. Access to the treasure wallet(s) 120 cryptocurrency would be through another game wallet 206 that the player 104 would setup in FIG. 2.

At present, the seed phrases for cryptocurrency wallets tend to be a list of 12 to 24 words from BIP 39 (Bitcoin Improvement Proposal #39) wordlist, which is a specific list of 2048 words. However, seed phrases in the future could include more than just words from the BIP 39 wordlist and may contain alphanumeric, numbers, letters, symbols, special characters, or other features to form a digitally reproducible seed phrase on electronic devices. This embodiment assumes that the seed phrases associated with a cryptocurrency wallet is a specific list words from the BIP 39 wordlist, that have a specific number of words and are arranged in a specific order.

Electronic art 140 is created by the owner(s)/creator(s) 102, where the owner(s)/creator(s) 102 use the treasure wallet(s) 120 seed phrases to incorporate seed phrases as clues 142 within the artwork. The clues are meant to give the player 104 hints to the words, the number or words, and the order of placement of the words that make up the treasure wallet(s) 120 seed phrases. The electronic art 140 may be in any sensory stimulation form or format that can be digitized, but it will mainly be visual or auditory. Sensory forms include still images, clips, movies, songs, music, and the like. The clues incorporated into the electronic art 140 may also be in many different sensory forms that would allow a player 104 to determine the exact seed phrases including number of words and placement of words. Clues may also contain various techniques like wordplay, anagrams, puzzles, ciphers, poems, riddles, acronyms, and the like. Clues may also comprise any form of letters, numbers, characters, symbols, sounds, pictures, drawings, doodles, maps, or any other combination of sensory information the owner(s)/creator(s) 102 determine will assist a player 104 in determining the treasure wallet(s) 120 seed phrases.

An NFT Marketplace 150 is a central location for cryptocurrency users to create, buy, market, and sell NFTs. The NFT Marketplace 150 is where the owner(s)/creator(s) 102 and players interact in the digital crypto treasure hunt. Once the owner(s)/creator(s) 102 and players create a user account 152 in the NFT Marketplace 150, they have access to activities and functions of the NFT Marketplace 150. The owner(s)/creator(s) 102 then create a cryptographically secured asset of the electronic art 140. This embodiment shows that the owner(s)/creator(s) 102 would create that cryptographically secured asset of the electronic art 140 within the NFT Marketplace 150 by converting the electronic art 140 to create NFTs 154. The NFT can then be marketed and sold to a player 104 in the NFT Marketplace 150. The sale of the NFT allows the player 104 access to the NFT electronic art 140 so they may begin to determine the treasure wallet(s) 120 seed phrases based on the clues provided in the artwork.

The sale of the NFT triggers a smart contract 158 that can either send cryptocurrency automatically to predefined wallet address(es) at a predefined percentage(s) or the smart contract allows the calling of the cryptocurrency sale proceeds into the user account 152 or the owner/creator wallet(s) 110, a portion of which is sent to the treasure wallet(s) 120.

This embodiment assumes that the smart contract can only send the sale and royalties of the resale proceeds to a single cryptocurrency wallet address, like ERC-721 specifications, US Published Patent No. U.S. Pat. No. 20190164151, where contracts with ERC-721 associated with ERC-20 tokens allow for a single cryptocurrency wallet address for payment or royalties. This embodiment assumes a single cryptocurrency wallet within the owner/creator wallet(s) 110 is the controlling wallet for NFT Marketplace 150 user accounts and transactions. The owner(s)/creator(s) 102 then sends a portion of the sale proceeds from the owner/creator wallet(s) 110 to the treasure wallet(s) 120. If other owners or creators are involved and are allowed a portion of the sale or resale proceeds, then the owner(s)/creator(s) 102 can use the controlling owner/creator wallet(s) 110 to send other portions of the sale or resale proceeds to any other owner/creator wallet(s) 110.

The player 104 in this embodiment would either have or set up their own cryptocurrency wallet or wallets, hereafter called player wallet(s) 130, to create a user account 152 in the NFT Marketplace 150 to purchase NFTs associated with the digital crypto treasure hunt. Once the player 104 purchases the NFT they have access to the electronic art 140 and, through careful investigation of the artwork, can determine the clues that make up the treasure wallet(s) 120 seed phrases. The player 104 may move NFTs that they own to any other cryptocurrency wallets, NFT Marketplaces, or other sites that accept NFTs. The player 104 may also resell the previously purchased NFT on the NFT Marketplace 150, with the resell proceeds going to the player wallet(s) 130 and a portion, depending on the NFT Marketplace 150 and smart contract, going to the owner/creator wallet(s) 110.

FIG. 1b is a diagram of an embodiment of the process for creating a digital crypto treasure hunt by using the seed phrases of a treasure wallet within electronic art 140 that is cryptographically secured as an NFT and sold to players on an NFT Marketplace 150 where the sale triggers a smart contract that automatically sends sale proceeds to the owner/creator wallet(s) 110 and treasure wallet(s) 120 based on the predefined smart contract percentages.

There are two groups that make up the users of the digital crypto treasure hunt, the owner(s)/creator(s) 102 and the players. There may be one or more owner or creator, hereafter referred to as owner(s)/creator(s) 102, that use electronic devices, such as computers, electronic pads and mobile phones to complete the process of setting up owner/creator wallet(s) 110, treasure wallet(s) 120, create electronic art 140, convert electronic art 140 to a non-fungible token (NFT), and interact with a NFT Marketplace 150 to create a user account 152, create NFTs 154, and market NFTs for sale 156. A player 104 would use electronic devices, such as computers or mobile phones, to create their own player wallet(s) 130 that would be used to purchase NFTs created by the owner(s)/creator(s) 102 in the quest to win the cryptocurrency in the digital crypto treasure hunt. While this embodiment assumes a single player 104 in FIG. 1a, there could be multiple people that represent the player 104 as defined in this embodiment.

In this embodiment the owner(s)/creator(s) 102 set up a cryptocurrency wallet or wallets, hereafter referred to as the owner/creator wallet(s) 110, to be used for the sending and receiving of various cryptocurrencies for the activities associated with the creation of the digital crypto treasure hunt. For this embodiment the owner/creator wallet(s) 110 are used as the main cryptocurrency wallet connection and interface with the NFT Marketplace 150. The owner/creator wallet(s) 110 through the user account 152 in the NFT Marketplace 150, may then transfer cryptocurrency to pay for various fees in the creation, sale, resale, marketing, and minting of NFTs, along with paying of fees for other activities associated with the NFT Marketplace 150. The owner/creator wallet(s) 110 are also used to receive proceeds from the sale and resale of NFTs and then transfer a portion of the sale or resale proceeds to the treasure wallet(s) 120.

One of the main components of the digital crypto treasure hunt is for the owner(s)/creator(s) 102 to set up a cryptocurrency wallet or wallets, hereafter referred to as the treasure wallet(s) 120, where the setup of the wallet will generate seed phrases 122 which are then used by the owner(s)/creator(s) 102 to create electronic art 140 that are embedded with clues as to the seed phrases of the treasure wallet(s) 120. Another purpose of the treasure wallet(s) 120 is to receive a portion of the sale and resale proceeds of the electronic art 140 or NFT. A player 104 may then access the cryptocurrency within the treasure wallet(s) 120, as defined on the blockchain, if the player 104 is able to determine the seed phrases of the treasure wallet(s) 120. Access to the treasure wallet(s) 120 cryptocurrency would be through another game wallet 206 that the player 104 would setup in FIG. 2.

At present, the seed phrases for cryptocurrency wallets tend to be a list of 12 to 24 words from BIP 39 (Bitcoin Improvement Proposal #39) wordlist, which is a specific list of 2048 words. However, seed phrases in the future could include more than just words from the BIP 39 wordlist and may contain alphanumeric, numbers, letters, symbols, special characters, or other features to form a digitally reproducible seed phrase on electronic devices. This embodiment assumes that the seed phrases associated with a cryptocurrency wallet is a specific list words from the BIP 39 wordlist, that have a specific number of words and are arranged in a specific order.

Electronic art 140 is created by the owner(s)/creator(s) 102, where the owner(s)/creator(s) 102 use the treasure wallet(s) 120 seed phrases to incorporate seed phrases as clues 142 within the artwork. The clues are meant to give the player 104 hints to the words, the number or words, and the order of placement of the words that make up the treasure wallet(s) 120 seed phrases. The electronic art 140 may be in any sensory stimulation form or format that can be digitized, but it will mainly be visual or auditory. Sensory forms include still images, clips, movies, songs, music, and the like. The incorporated clues may also be given in many different sensory forms that would allow a player 104 to determine the exact seed phrases including number of words and placement of words. Clues may also comprise any form of letters, numbers, characters, symbols, sounds, pictures, drawings, doodles, maps, or any other combination of sensory information the owner(s)/creator(s) 102 determine will assist a player 104 in determining the treasure wallet(s) 120 seed phrases.

An NFT Marketplace 150 is a central location for cryptocurrency users to create, buy, market, and sell NFTs. The NFT Marketplace 150 is where the owner(s)/creator(s) 102 and players interact in the digital crypto treasure hunt. Once the owner(s)/creator(s) 102 and players create a user account 152 in the NFT Marketplace 150, they have access to activities and functions of the NFT Marketplace 150. The owner(s)/creator(s) 102 then create a cryptographically secured asset of the electronic art 140. This embodiment shows that the owner(s)/creator(s) 102 would create that cryptographically secured asset of the electronic art 140 within the NFT Marketplace 150 by converting the electronic art 140 to create NFTs 154. The NFT can then be marketed and sold to a player 104 in the NFT Marketplace 150. The sale of the NFT allows the player 104 access to the NFT electronic art 140 so they may begin to determine the treasure wallet(s) 120 seed phrases based on the clues provided in the artwork.

The sale of the NFT triggers a smart contract 158 that can either send cryptocurrency automatically to predefined wallet address(es) at a predefined percentage(s) or the smart contract allows the calling of the cryptocurrency sale proceeds into the user account 152 or the owner/creator wallet(s) 110, a portion of which is sent to the treasure wallet(s) 120.

This embodiment assumes that the smart contract automatically sends the sale and royalties of the resale proceeds to multiple cryptocurrency wallet addresses at varying percentages, like ERC-2981 specifications, where contracts with ERC-2981 associated with ERC-20 tokens allow for a plurality of cryptocurrency wallet addresses, for payment or royalties at varying percentages for each cryptocurrency wallet. In this embodiment a percentage of the sale proceeds would be sent to the owner/creator wallet(s) 110 and treasure wallet(s) 120 at predetermined percentages. In the resale condition a set percentage of the total or royalty would go the owner/creator wallet(s) 110 and treasure wallet(s) 120 at predetermined percentages, with the remainder automatically being sent to the player wallet(s) 130.

The player 104 in this embodiment would either have or set up their own cryptocurrency wallet or wallets, hereafter called player wallet(s) 130, to create a user account 152 in the NFT Marketplace 150 to purchase NFTs associated with the digital crypto treasure hunt. Once the player 104 purchases the NFT they have access to the electronic art 140 and, through careful investigation of the artwork, can determine the clues that make up the treasure wallet(s) 120 seed phrases. The player 104 may move NFTs that they own to any other cryptocurrency wallets, NFT Marketplaces, or other sites that accept NFTs. The player 104 may also resell the previously purchased NFT on the NFT Marketplace 150, with the resell proceeds going to the player wallet(s) 130 and a portion, depending on the NFT Marketplace 150 and smart contract, going to the owner/creator wallet(s) 110.

FIG. 1c is a diagram of an embodiment of the process for creating a digital crypto treasure hunt by using the seed phrases of a treasure wallet within electronic art 140 that is cryptographically secured as an NFT and sold to players on an NFT Marketplace 150 where the proceeds are sent to the treasure wallet(s) 120 for distribution.

There are two groups that make up the users of the digital crypto treasure hunt, the owner(s)/creator(s) 102 and the players. There may be one or more owner or creator, hereafter referred to as owner(s)/creator(s) 102, that use electronic devices, such as computers, electronic pads and mobile phones to complete the process of setting up owner/creator wallet(s) 110, treasure wallet(s) 120, create electronic art 140, covert electronic art 140 to a non-fungible token (NFT), and interact with a NFT Marketplace 150 to create a user account 152, create NFTs 154, and market NFTs for sale 156. A player 104 would use electronic devices, such as computers or mobile phones, to create their own player wallet(s) 130 that would be used to purchase NFTs created by the owner(s)/creator(s) 102 in the quest to win the cryptocurrency in the digital crypto treasure hunt. While this embodiment assumes a single player 104, there could be multiple people that represent the player 104 as defined in this embodiment.

In this embodiment the owner(s)/creator(s) 102 set up a cryptocurrency wallet or

wallets, hereafter referred to as the owner/creator wallet(s) 110, to be used for the sending and receiving of various cryptocurrencies for the activities associated with the creation of the digital crypto treasure hunt. In this embodiment the main purpose of owner/creator wallet(s) 110 is to receive sale and resale proceeds from the treasure wallet(s) 120, which are used as the main transactional wallet with the NFT Marketplace 150.

One of the main components of the digital crypto treasure hunt is for the owner(s)/creator(s) 102 to set up a cryptocurrency wallet or wallets, hereafter referred to as the treasure wallet(s) 120, where the setup of the wallet will generate seed phrases 122 which are then used by the owner(s)/creator(s) 102 to create electronic art 140 that are embedded with clues as to the seed phrases of the treasure wallet(s) 120. Another purpose of the treasure wallet(s) 120 is to receive a portion of the sale and resale proceeds of the electronic art 140 or NFT. A player 104 may then access the cryptocurrency within the treasure wallet(s) 120, as defined on the blockchain, if the player 104 is able to determine the seed phrases of the treasure wallet(s) 120. Access to the treasure wallet(s) 120 cryptocurrency would be through another game wallet 206 that the player 104 would setup in FIG. 2. For this embodiment the owner(s)/creator(s) 102 use the treasure wallet(s) 120 as the main cryptocurrency wallet connection and interface with the NFT Marketplace 150. The treasure wallet(s) 120, through the user account 152 in the NFT Marketplace 150, may then transfer cryptocurrency to pay for various fees in the creation, sale, resale, marketing, and minting of NFTs, along with paying of fees for other activities associated with the NFT Marketplace 150. The treasure wallet(s) 120 are also used to receive proceeds from the sale and resale of NFTs and then transfer a portion of the sale or resale proceeds to the owner/creator wallet(s) 110.

At present, the seed phrases for cryptocurrency wallets tend to be a list of 12 to 24 words from BIP 39 (Bitcoin Improvement Proposal #39) wordlist, which is a specific list of 2048 words. However, seed phrases in the future could include more than just words from the BIP 39 wordlist and may contain alphanumeric, numbers, letters, symbols, special characters, or other features to form a digitally reproducible seed phrase on electronic devices. This embodiment assumes that the seed phrases associated with a cryptocurrency wallet is a specific list words from the BIP 39 wordlist, that have a specific number of words and are arranged in a specific order.

Electronic art 140 is created by the owner(s)/creator(s) 102, where the owner(s)/creator(s) 102 use the treasure wallet(s) 120 seed phrases to incorporate seed phrases as clues 142 within the artwork. The clues are meant to give the player 104 hints to the words, the number or words, and the order of placement of the words that make up the treasure wallet(s) 120 seed phrases. The electronic art 140 may be in any sensory stimulation form or format that can be digitized, but it will mainly be visual or auditory. Sensory forms include still images, clips, movies, songs, music, and the like. The incorporated clues may also be given in many different sensory forms that would allow a player 104 to determine the exact seed phrases including number of words and placement of words. Clues may also comprise any form of letters, numbers, characters, symbols, sounds, pictures, drawings, doodles, maps, or any other combination of sensory information the owner(s)/creator(s) 102 determine will assist a player 104 in determining the treasure wallet(s) 120 seed phrases.

An NFT Marketplace 150 is a central location for cryptocurrency users to create, buy, market, and sell NFTs. The NFT Marketplace 150 is where the owner(s)/creator(s) 102 and players interact in the digital crypto treasure hunt. Once the owner(s)/creator(s) 102 and players create a user account 152 in the NFT Marketplace 150, they have access to activities and functions of the NFT Marketplace 150. The owner(s)/creator(s) 102 then create a cryptographically secured asset of the electronic art 140. This embodiment shows that the owner(s)/creator(s) 102 would create that cryptographically secured asset of the electronic art 140 within the NFT Marketplace 150 by converting the electronic art 140 to create NFTs 154. The NFT can then be marketed and sold to a player 104 in the NFT Marketplace 150. The sale of the NFT allows the player 104 access to the NFT electronic art 140 so they may begin to determine the treasure wallet(s) 120 seed phrases based on the clues provided in the artwork.

The sale of the NFT triggers a smart contract 158 that can either send cryptocurrency automatically to predefined wallet address(es) at a predefined percentage(s) or the smart contract allows the calling of the cryptocurrency sale proceeds into the user account 152 or the owner/creator wallet(s) 110, a portion of which is sent to the treasure wallet(s) 120.

This embodiment assumes that the smart contract can only send the sale and royalties of the resale proceeds to a single cryptocurrency wallet address, like ERC-721 specifications, US Published Patent No. 20190164151, where contracts with ERC-721 associated with ERC-20 tokens allow for a single cryptocurrency wallet address for payment or royalties. This embodiment assumes a single cryptocurrency wallet within one of the treasure wallet(s) 120 as the controlling wallet for NFT Marketplace 150 user accounts and transactions. The owner(s)/creator(s) 102 then sends a portion of the sale proceeds from the treasure wallet(s) 120 to the owner/creator wallet(s) 110 for their respective portions.

The player 104 in this embodiment would either have or set up their own cryptocurrency wallet or wallets, hereafter called player wallet(s) 130, to create a user account 152 in the NFT Marketplace 150 to purchase NFTs associated with the digital crypto treasure hunt. Once the player 104 purchases the NFT they have access to the electronic art 140 and, through careful investigation of the artwork, can determine the clues that make up the treasure wallet(s) 120 seed phrases. The player 104 may move NFTs that they own to any other cryptocurrency wallets, NFT Marketplaces, or other sites that accept NFTs. The player 104 may also resell the previously purchased NFT on the NFT Marketplace 150, with the resell proceeds going to the player wallet(s) 130 and a portion, depending on the NFT Marketplace 150 and smart contract, going to the owner/creator wallet(s) 110.

The limiting factor in this embodiment is that once a player 104 has access to the treasure wallet(s) 120 and can move cryptocurrency to a game wallet 206, it may be difficult to have cryptocurrency assets in the treasure wallet(s) 120 long enough to pay for any fees for marketplace activities or send portions to the owner(s)/creator(s) 102.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

FIG. 2 is a flow chart of an example method 200 for a player 104 to acquire an NFT 202 to discover the clues of the seed phrases of the treasure wallet, then create a game wallet 206 using their guesses of seed phrases of the treasure wallet to gain access to the cryptocurrency of the treasure wallet.

In this embodiment a player 104 is referred to as the player 104 in FIGS. 1a, 1b and 1c. Initially, the example method 200 includes an act (act 202) of a player 104 that would acquire an NFT 202, typically by purchasing the NFT from the NTF Marketplace, as defined in FIGS. 1a, 1b and 1c.

Act 204 involves the player 104 performing a clue search 204 within the NFT to determine the treasure wallet(s) 120 seed phrases, including the correct words, the correct number of words, and the correct order of the words. Clues within the NFT make be in many forms as described, but not limited to, the ones listed in FIGS. 1a, 1b, and 1c.

Once a player 104 has determined what they believe to be the correct seed phrases of the treasure wallet, then act 206 involves the player 104 setting up a new cryptocurrency wallet called a game wallet 206, to test the validity of the player's guess. In act 208 the player 104 would use the seed phrases of the treasure wallet as the seed phrases for the new game wallet set up 208 in an attempt tie the game wallet 206 to the treasure wallet through the information listed on the blockchain that is tied to the treasure wallet seed phrases and transactions.

In the decision act 210, if the player 104 enters the seed phases incorrectly they would have to go back to act 204, and if they have seed phrases entered correctly 210, they would move on to act 212. For the player 104 to be successful in creating the game wallet 206 to tie to the treasure wallet's blockchain information, the player 104 would have to use the correct treasure wallet seed phrases, including the correct words, number of words, and order of words, in the game wallet 206 setup.

In act 212 the newly created game wallet 206, with the correct treasure wallet seed phrases entered in at the game wallet set up 208, would now be able to view and have access to treasure wallet cryptocurrency 212 as identified on the blockchain.

Act 214 is where the player 104 would move cryptocurrency from game wallet 214 to any other cryptocurrency wallet, cryptocurrency exchange, or other site that accepts cryptocurrency. While this step is not required, it would be recommended for the player 104 to do this in order to prevent other players who may also have the correct guess of the treasure wallet seed phrases from gaining access to the treasure wallet cryptocurrency. Moving the cryptocurrency ensures the first player 104 to guess the seed phrases of the treasure wallet correctly would access and be able to move the cryptocurrency, minus any fees that may be required to move the cryptocurrency, thereby making the moved cryptocurrency inaccessible to any other players. Because other players may still be buying and selling NFTs related to the digital crypto treasure hunt, the wallet may continue to see cryptocurrency funds enter the wallet well into the future. If multiple players have set up game wallets with the correct treasure wallet seed phrases then they would all have visibility and access to the cryptocurrency and the first player 104 that would move it to another cryptocurrency wallet or exchange would be the only one with access to that moved cryptocurrency.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A system and method for digital crypto treasure hunt using cryptographically secured assets and cryptocurrency wallet seed phrases within electronic art for to provide a cryptographically secured asset or assets for sale and resale that provide clues within the electronic artwork to a cryptocurrency treasure wallet seed phrases to provide a means for a user to access the treasure wallet as a means to win a digital cryptocurrency treasure hunt, comprising:
means for a person or persons responsible for the creation of various cryptocurrency wallets, electronic art, NFTs, as well as the interaction between cryptocurrency wallets and NFT marketplace for marketing, sale, and dissemination of funds between various cryptocurrency wallets;
means for a person or persons who would participate in the digital crypto hunting game through the purchase of NFTs) from NFT marketplace to determine seed phrases of the treasure wallet(s), and the creation of game wallet to enter treasure wallet seed phrases guesses into the game wallet to access the treasure wallet cryptocurrency;
means for obtaining cryptocurrency from cryptocurrency exchanges to transfer to NFT marketplace for various fees and for receiving cryptocurrency from the sale of NFTs;
means for the creation of seed phrases in wallet setup to be used to generate clues within the creation of electronic art to be sold as an NFT, to accept a portion of the cryptocurrency proceeds for the sale and resale of the NFT and to allow access to any or all of the cryptocurrency sent to this wallet for the player who determines the correct seed phrase, including the correct spelling, number and order of placement of the seed phrases;
means for creation of treasure wallet seed phrases for the incorporation of these seed phrases into electronic art as clues to the nature of the word, number of words, and the order of the words associated with the treasure wallet;
means for the connection and access the NFT marketplace, transferring cryptocurrency for the purpose of buying and selling of NFTs, to receive any purchased NFTs or to receive proceeds from the resale of previously purchased NFTs;
means for creation of electronic art with various electronic devices that incorporates clues within the artwork as to the treasure wallet's seed phrases that allow a player to determine, through careful study and analysis, the correct words, number of words, and order of the words that constitute the seed phrases of the treasure wallet;
means for incorporation of clues within the electronic art to allow a player to determine the exact words, number of words, and order of placement of the words that constitute the seed phrases of the treasure wallet;
means for setting up of user accounts for the sending and receiving of cryptocurrencies for the creation of NFTs from electronic art and the purchase, sale and resale of those NFTs, central location for the marketing of NFTs and for the calling or distribution of proceeds from the purchase, sale and resale of NFTs;
means for the setting up of a user account on the NFT marketplace to allow for a tie to a cryptocurrency wallet used in various cryptocurrency and NFT transactions, paying fees for marketing and sales, transfer of NFTs, transfer of proceeds from sales and resales to a cryptocurrency wallet, acceptance of cryptocurrency for purchases from a wallet, transfer of cryptocurrency for minting fees or fees for the creation of NFTs, and other marketplace functions and costs;
means for turning the electronic art into a unique NFT by attaching a smart contract to the electronic art through crypto minting or other means to register it on the blockchain;
means for marketing of NFTs for sale within the NFT marketplace to entice players to purchase the NFTs;
means for sale or resale of the NFT triggers the smart contract which would push or allow the calling of sale or resale proceeds to one or more cryptocurrency wallet;
means for the acquisition of an NFT, typically by purchasing the NFT through an NFT marketplace, to allow a player to participate in the digital crypto treasure hunt;
means for the determination of the treasure wallet seed phrases, through careful study and examination, using the NFT art, knowledge of past or present events, external references, and the like, to determine the exact words, number of words, and order of words that make up the treasure wallet seed phrases;
means for the creation of a game wallet to test the guesses of the treasure wallet seed phrases in the attempt to tie the game wallet to the same seed phrases of the treasure wallet;
means for the setup of the game wallet using the guesses for the treasure wallet seed phrases to gain access to the treasure wallet cryptocurrency;
means for the attempt to enter the guesses within the setup of the game wallet to determine if the guesses of the seed phrases match the treasure wallet seed phrases;
means for the way to access the treasure wallet cryptocurrency by entering correctly in the set up of the game wallet the treasure wallet seed phrases, including the correct words, number of words, and order of the words; and
means for the acquisition of NFTs that a player would use to guess the correct treasure wallet seed phrases which are further used to set up a new game wallet that, if the seed phrases guessed and entered in the setup, match the treasure wallet seed phrases, will allow a player to access the treasure wallet cryptocurrency through the game wallet.

2. The system and method for digital crypto treasure hunt using cryptographically secured assets and cryptocurrency wallet seed phrases within electronic art in accordance with claim 1, wherein said means for a person or persons responsible for the creation of various cryptocurrency wallets, electronic art, NFTs, as well as the interaction between cryptocurrency wallets and NFT marketplace for marketing, sale, and dissemination of funds between various cryptocurrency wallets comprises a means to create cryptocurrency wallets, means to create NFTs, means to move cryptocurrency between cryptocurrency wallets and NFT marketplace owner(s)/creator(s).

3. The system and method for digital crypto treasure hunt using cryptographically secured assets and cryptocurrency wallet seed phrases within electronic art in accordance with claim 1, wherein said means for a person or persons who would participate in the digital crypto hunting game through the purchase of NFTs) from NFT marketplace to determine seed phrases of the treasure wallet(s), and the creation of game wallet to enter treasure wallet seed phrases guesses into the game wallet to access the treasure wallet cryptocurrency comprises a means to own cryptocurrency wallet, means to use a cryptocurrency wallet to interact with NFT marketplace to buy NFTs, means to determine treasure cryptocurrency wallet seed phrases by using clues in the NFT player.

4. The system and method for digital crypto treasure hunt using cryptographically secured assets and cryptocurrency wallet seed phrases within electronic art in accordance with claim 1, wherein said means for obtaining cryptocurrency from cryptocurrency exchanges to transfer to NFT marketplace for various fees and for receiving cryptocurrency from the sale of NFTs comprises a means to interact with cryptocurrency exchanges to obtain cryptocurrency, means to transfer cryptocurrency to pay NFT marketplace fees, means to accept transfers of cryptocurrency from NFT smart contract or NFT marketplace owner/creator wallet(s).

5. The system and method for digital crypto treasure hunt using cryptographically secured assets and cryptocurrency wallet seed phrases within electronic art in accordance with claim 1, wherein said means for the creation of seed phrases in wallet setup to be used to generate clues within the creation of electronic art to be sold as an NFT, to accept a portion of the cryptocurrency proceeds for the sale and resale of the NFT and to allow access to any or all of the cryptocurrency sent to this wallet for the player who determines the correct seed phrase, including the correct spelling, number and order of placement of the seed phrases comprises a means to obtain seed phrases to be used within creation of electronic art to give clues as to the words and order of the seed phrases, means to receive a portion of the cryptocurrency proceeds for the sale or resale of the electronic art sold as an NFT, means to allow access to any or all of the cryptocurrency proceeds for players that are able to determine the correct words and order of the seed phrases within another game wallet treasure wallet(s).

6. The system and method for digital crypto treasure hunt using cryptographically secured assets and cryptocurrency wallet seed phrases within electronic art in accordance with claim 1, wherein said means for creation of treasure wallet seed phrases for the incorporation of these seed phrases into electronic art as clues to the nature of the word, number of words, and the order of the words associated with the treasure wallet comprises a means to generate a list of unique words, typically 12 to 24, set in a specific order upon creation of the cryptocurrency wallet, that allows access to the cryptocurrency associated with the wallet and transactions on the blockchain, otherwise known as seed phrases or seed recovery phrases, means where seed phrases can be entered in at the creation of cryptocurrency wallets to gain access to the cryptocurrency and transactions on the blockchain that are associated with that unique set of seed phrases generate seed phrases.

7. The system and method for digital crypto treasure hunt using cryptographically secured assets and cryptocurrency wallet seed phrases within electronic art in accordance with claim 1, wherein said means for the connection and access the NFT marketplace, transferring cryptocurrency for the purpose of buying and selling of NFTs, to receive any purchased NFTs or to receive proceeds from the resale of previously purchased NFTs comprises a means to send cryptocurrency to other cryptocurrency wallets, exchanges and NFT marketplaces, means to receive cryptocurrency from the resale of any previously owned NFTs, means to receive NFTs that have been purchased, if the player chooses to move from the NFT marketplace to the wallet, means to connect to NFT marketplaces to allow the setup of user accounts that then allow for the purchase and sale of NFTs player wallet(s).

8. The system and method for digital crypto treasure hunt using cryptographically secured assets and cryptocurrency wallet seed phrases within electronic art in accordance with claim 1, wherein said means for creation of electronic art with various electronic devices that incorporates clues within the artwork as to the treasure wallet's seed phrases that allow a player to determine, through careful study and analysis, the correct words, number of words, and order of the words that constitute the seed phrases of the treasure wallet comprises a means to create digital electronic art that uses various sensory stimulation in the art, mainly visual and auditory, means to save art in some electronic or digital format that can be viewed or replicated on other electronic devices, means to save in a format that a crypto smart contract can be attached electronic art.

9. The system and method for digital crypto treasure hunt using cryptographically secured assets and cryptocurrency wallet seed phrases within electronic art in accordance with claim 1, wherein said means for incorporation of clues within the electronic art to allow a player to determine the exact words, number of words, and order of placement of the words that constitute the seed phrases of the treasure wallet comprises a means where clues are incorporated within the electronic art and can be in any form determined by the owner/creator as to assisting the player in determine the words, number of words, and order of the words of the seed phrases of the treasure wallet(s), means where the clues to the seed phrases may be in one or multiple electronic art pieces incorporate seed phrases as clues.

10. The system and method for digital crypto treasure hunt using cryptographically secured assets and cryptocurrency wallet seed phrases within electronic art in accordance with claim 1, wherein said means for setting up of user accounts for the sending and receiving of cryptocurrencies for the creation of NFTs from electronic art and the purchase, sale and resale of those NFTs, central location for the marketing of NFTs and for the calling or distribution of proceeds from the purchase, sale and resale of NFTs comprises a means for the sending and receiving of various cryptocurrencies, means to accept electronic art for the creation of NFTs, means for the creation of NFTs through minting or other processes, means for the setting up of accounts for the creation of NFTs from electronic art, means for accounts to purchase, sell and resell NFTs, means for the marketing of NFTs for sale or resale, means for the calling or distribution of proceeds after purchase, sale or resale of NFTs NFT marketplace.

11. The system and method for digital crypto treasure hunt using cryptographically secured assets and cryptocurrency wallet seed phrases within electronic art in accordance with claim 1, wherein said means for the setting up of a user account on the NFT marketplace to allow for a tie to a cryptocurrency wallet used in various cryptocurrency and NFT transactions, paying fees for marketing and sales, transfer of NFTs, transfer of proceeds from sales and resales to a cryptocurrency wallet, acceptance of cryptocurrency for purchases from a wallet, transfer of cryptocurrency for minting fees or fees for the creation of NFTs, and other marketplace functions and costs comprises a means for the account creation ties NFT marketplace to a specific wallet to be used in various cryptocurrency and NFT transactions user account.

12. The system and method for digital crypto treasure hunt using cryptographically secured assets and cryptocurrency wallet seed phrases within electronic art in accordance with claim 1, wherein said means for turning the electronic art into a unique NFT by attaching a smart contract to the electronic art through crypto minting or other means to register it on the blockchain comprises a means to obtain a unique blockchain identification associated with the electronic art and identified on the blockchain or distributed ledger, means for the sale and resale of the NFT, which triggers an attached smart contract with predefined parameters as to what to do with the proceeds of the sale or resale, means for the NFT identification on the blockchain to be allowed to be transferred within the blockchain to other cryptocurrency wallets, NFT marketplaces or cryptocurrency exchanges create NFTs.

13. The system and method for digital crypto treasure hunt using cryptographically secured assets and cryptocurrency wallet seed phrases within electronic art in accordance with claim 1, wherein said means for marketing of NFTs for sale within the NFT marketplace to entice players to purchase the NFTs comprises a means for listing of NFTs for various prices and types of cryptocurrencies market NFTs for sale.

14. The system and method for digital crypto treasure hunt using cryptographically secured assets and cryptocurrency wallet seed phrases within electronic art in accordance with claim 1, wherein said means for sale or resale of the NFT triggers the smart contract which would push or allow the calling of sale or resale proceeds to one or more cryptocurrency wallet comprises a means for the sale of the NFT to trigger a smart contract, which lists one or more cryptocurrencies wallet addresses as owner or creator of the NFT, means for the sale of the NFT to trigger a smart contract which may list, for multiple wallets, the percentage of funds to be distributed between the wallets, means for the sale of the NFT to trigger a smart contract that may allow the calling of sale proceeds to be deliver to one or more wallets sale of the NFT triggers a smart contract.

15. The system and method for digital crypto treasure hunt using cryptographically secured assets and cryptocurrency wallet seed phrases within electronic art in accordance with claim 1, wherein said means for the acquisition of an NFT, typically by purchasing the NFT through an NFT marketplace, to allow a player to participate in the digital crypto treasure hunt comprises a means to acquire an NFT, typically through purchasing the NFT in a NFT marketplace, to participate in the crypto treasure hunt acquire an NFT.

16. The system and method for digital crypto treasure hunt using cryptographically secured assets and cryptocurrency wallet seed phrases within electronic art in accordance with claim 1, wherein said means for the determination of the treasure wallet seed phrases, through careful study and examination, using the NFT art, knowledge of past or present events, external references, and the like, to determine the exact words, number of words, and order of words that make up the treasure wallet seed phrases comprises a means to determine the treasure wallet seed phrases by careful examination of the NFT for clues that will help determine the correct words, number of words and order of words that make up the treasure wallet seed phrases clue search.

17. The system and method for digital crypto treasure hunt using cryptographically secured assets and cryptocurrency wallet seed phrases within electronic art in accordance with claim 1, wherein said means for the creation of a game wallet to test the guesses of the treasure wallet seed phrases in the attempt to tie the game wallet to the same seed phrases of the treasure wallet comprises a means to tie the cryptocurrency within the treasure wallet to the newly created game wallet game wallet.

18. The system and method for digital crypto treasure hunt using cryptographically secured assets and cryptocurrency wallet seed phrases within electronic art in accordance with claim 1, wherein said means for the setup of the game wallet using the guesses for the treasure wallet seed phrases to gain access to the treasure wallet cryptocurrency comprises a means to enter the guesses that would be the exact treasure wallet seed phrases, including the correct words, number of words, and order of words that make up the treasure wallet seed phrases game wallet set up.

19. The system and method for digital crypto treasure hunt using cryptographically secured assets and cryptocurrency wallet seed phrases within electronic art in accordance with claim 1, wherein said means for the attempt to enter the guesses within the setup of the game wallet to determine if the guesses of the seed phrases match the treasure wallet seed phrases comprises a means to determine if the seed phrases entered into the game wallet are exactly the same as those for the treasure wallet seed phrases entered correctly.

20. The system and method for digital crypto treasure hunt using cryptographically secured assets and cryptocurrency wallet seed phrases within electronic art in accordance with claim 1, wherein said means for the way to access the treasure wallet cryptocurrency by entering correctly in the set up of the game wallet the treasure wallet seed phrases, including the correct words, number of words, and order of the words comprises a means for the correct entry of the seed phrases that match exactly the treasure wallet seed phrases in the set up of the game wallet to gain access to any or all of the cryptocurrency within the treasure wallet as recorded on the blockchain access to treasure wallet cryptocurrency.

21. The system and method for digital crypto treasure hunt using cryptographically secured assets and cryptocurrency wallet seed phrases within electronic art in accordance with claim 1, wherein said means for the acquisition of NFTs that a player would use to guess the correct treasure wallet seed phrases which are further used to set up a new game wallet that, if the seed phrases guessed and entered in the setup, match the treasure wallet seed phrases, will allow a player to access the treasure wallet cryptocurrency through the game wallet comprises a method to acquire NFTs used to guess the correct treasure wallet seed phrases which are used to set up a new game wallet that can access the treasure wallet cryptocurrency example method.

22. A system and method for digital crypto treasure hunt using cryptographically secured assets and cryptocurrency wallet seed phrases within electronic art for to provide a cryptographically secured asset or assets for sale and resale that provide clues within the electronic artwork to a cryptocurrency treasure wallet seed phrases to provide a means for a user to access the treasure wallet as a means to win a digital cryptocurrency treasure hunt, comprising:
a means to create cryptocurrency wallets, means to create NFTs, means to move cryptocurrency between cryptocurrency wallets and NFT marketplace owner(s)/creator(s), for a person or persons responsible for the creation of various cryptocurrency wallets, electronic art, NFTs, as well as the interaction between cryptocurrency wallets and NFT marketplace for marketing, sale, and dissemination of funds between various cryptocurrency wallets;
a means to own cryptocurrency wallet, means to use a cryptocurrency wallet to interact with NFT marketplace to buy NFTs, means to determine treasure cryptocurrency wallet seed phrases by using clues in the NFT player, for a person or persons who would participate in the digital crypto hunting game through the purchase of NFTs) from NFT marketplace to determine seed phrases of the treasure wallet(s), and the creation of game wallet to enter treasure wallet seed phrases guesses into the game wallet to access the treasure wallet cryptocurrency;
a means to interact with cryptocurrency exchanges to obtain cryptocurrency, means to transfer cryptocurrency to pay NFT marketplace fees, means to accept transfers of cryptocurrency from NFT smart contract or NFT marketplace owner/creator wallet(s), for obtaining cryptocurrency from cryptocurrency exchanges to transfer to NFT marketplace for various fees and for receiving cryptocurrency from the sale of NFTs;
a means to obtain seed phrases to be used within creation of electronic art to give clues as to the words and order of the seed phrases, means to receive a portion of the cryptocurrency proceeds for the sale or resale of the electronic art sold as an NFT, means to allow access to any or all of the cryptocurrency proceeds for players that are able to determine the correct words and order of the seed phrases within another game wallet treasure wallet(s), for the creation of seed phrases in wallet setup to be used to generate clues within the creation of electronic art to be sold as an NFT, to accept a portion of the cryptocurrency proceeds for the sale and resale of the NFT and to allow access to any or all of the cryptocurrency sent to this wallet for the player who determines the correct seed phrase, including the correct spelling, number and order of placement of the seed phrases;
a means to generate a list of unique words, typically 12 to 24, set in a specific order upon creation of the cryptocurrency wallet, that allows access to the cryptocurrency associated with the wallet and transactions on the blockchain, otherwise known as seed phrases or seed recovery phrases, means where seed phrases can be entered in at the creation of cryptocurrency wallets to gain access to the cryptocurrency and transactions on the blockchain that are associated with that unique set of seed phrases generate seed phrases, for creation of treasure wallet seed phrases for the incorporation of these seed phrases into electronic art as clues to the nature of the word, number of words, and the order of the words associated with the treasure wallet;
a means to send cryptocurrency to other cryptocurrency wallets, exchanges and NFT marketplaces, means to receive cryptocurrency from the resale of any previously owned NFTs, means to receive NFTs that have been purchased, if the player chooses to move from the NFT marketplace to the wallet, means to connect to NFT marketplaces to allow the setup of user accounts that then allow for the purchase and sale of NFTs player wallet(s), for the connection and access the NFT marketplace, transferring cryptocurrency for the purpose of buying and selling of NFTs, to receive any purchased NFTs or to receive proceeds from the resale of previously purchased NFTs;
a means to create digital electronic art that uses various sensory stimulation in the art, mainly visual and auditory, means to save art in some electronic or digital format that can be viewed or replicated on other electronic devices, means to save in a format that a crypto smart contract can be attached electronic art, for creation of electronic art with various electronic devices that incorporates clues within the artwork as to the treasure wallet's seed phrases that allow a player to determine, through careful study and analysis, the correct words, number of words, and order of the words that constitute the seed phrases of the treasure wallet;
a means where clues are incorporated within the electronic art and can be in any form determined by the owner/creator as to assisting the player in determine the words, number of words, and order of the words of the seed phrases of the treasure wallet(s), means where the clues to the seed phrases may be in one or multiple electronic art pieces incorporate seed phrases as clues, for incorporation of clues within the electronic art to allow a player to determine the exact words, number of words, and order of placement of the words that constitute the seed phrases of the treasure wallet;
a means for the sending and receiving of various cryptocurrencies, means to accept electronic art for the creation of NFTs, means for the creation of NFTs through minting or other processes, means for the setting up of accounts for the creation of NFTs from electronic art, means for accounts to purchase, sell and resell NFTs, means for the marketing of NFTs for sale or resale, means for the calling or distribution of proceeds after purchase, sale or resale of NFTs NFT marketplace, for setting up of user accounts for the sending and receiving of cryptocurrencies for the creation of NFTs from electronic art and the purchase, sale and resale of those NFTs, central location for the marketing of NFTs and for the calling or distribution of proceeds from the purchase, sale and resale of NFTs;
a means for the account creation ties NFT marketplace to a specific wallet to be used in various cryptocurrency and NFT transactions user account, for the setting up of a user account on the NFT marketplace to allow for a tie to a cryptocurrency wallet used in various cryptocurrency and NFT transactions, paying fees for marketing and sales, transfer of NFTs, transfer of proceeds from sales and resales to a cryptocurrency wallet, acceptance of cryptocurrency for purchases from a wallet, transfer of cryptocurrency for minting fees or fees for the creation of NFTs, and other marketplace functions and costs;
a means to obtain a unique blockchain identification associated with the electronic art and identified on the blockchain or distributed ledger, means for the sale and resale of the NFT, which triggers an attached smart contract with predefined parameters as to what to do with the proceeds of the sale or resale, means for the NFT identification on the blockchain to be allowed to be transferred within the blockchain to other cryptocurrency wallets, NFT marketplaces or cryptocurrency exchanges create NFTs, for turning the electronic art into a unique NFT by attaching a smart contract to the electronic art through crypto minting or other means to register it on the blockchain;
a means for listing of NFTs for various prices and types of cryptocurrencies market NFTs for sale, for marketing of NFTs for sale within the NFT marketplace to entice players to purchase the NFTs;
a means for the sale of the NFT to trigger a smart contract, which lists one or more cryptocurrencies wallet addresses as owner or creator of the NFT, means for the sale of the NFT to trigger a smart contract which may list, for multiple wallets, the percentage of funds to be distributed between the wallets, means for the sale of the NFT to trigger a smart contract that may allow the calling of sale proceeds to be deliver to one or more wallets sale of the NFT triggers a smart contract, for sale or resale of the NFT triggers the smart contract which would push or allow the calling of sale or resale proceeds to one or more cryptocurrency wallet;
a means to acquire an NFT, typically through purchasing the NFT in a NFT marketplace, to participate in the crypto treasure hunt acquire an NFT, for the acquisition of an NFT, typically by purchasing the NFT through an NFT marketplace, to allow a player to participate in the digital crypto treasure hunt;
a means to determine the treasure wallet seed phrases by careful examination of the NFT for clues that will help determine the correct words, number of words and order of words that make up the treasure wallet seed phrases clue search, for the determination of the treasure wallet seed phrases, through careful study and examination, using the NFT art, knowledge of past or present events, external references, and the like, to determine the exact words, number of words, and order of words that make up the treasure wallet seed phrases;
a means to tie the cryptocurrency within the treasure wallet to the newly created game wallet game wallet, for the creation of a game wallet to test the guesses of the treasure wallet seed phrases in the attempt to tie the game wallet to the same seed phrases of the treasure wallet;
a means to enter the guesses that would be the exact treasure wallet seed phrases, including the correct words, number of words, and order of words that make up the treasure wallet seed phrases game wallet set up, for the setup of the game wallet using the guesses for the treasure wallet seed phrases to gain access to the treasure wallet cryptocurrency;
a means to determine if the seed phrases entered into the game wallet are exactly the same as those for the treasure wallet seed phrases entered correctly, for the attempt to enter the guesses within the setup of the game wallet to determine if the guesses of the seed phrases match the treasure wallet seed phrases;
a means for the correct entry of the seed phrases that match exactly the treasure wallet seed phrases in the set up of the game wallet to gain access to any or all of the cryptocurrency within the treasure wallet as recorded on the blockchain access to treasure wallet cryptocurrency, for the way to access the treasure wallet cryptocurrency by entering correctly in the set up of the game wallet the treasure wallet seed phrases, including the correct words, number of words, and order of the words; and
a method to acquire NFTs used to guess the correct treasure wallet seed phrases which are used to set up a new game wallet that can access the treasure wallet cryptocurrency example method, for the acquisition of NFTs that a player would use to guess the correct treasure wallet seed phrases which are further used to set up a new game wallet that, if the seed phrases guessed and entered in the setup, match the treasure wallet seed phrases, will allow a player to access the treasure wallet cryptocurrency through the game wallet.

23. The system and method for digital crypto treasure hunt using cryptographically secured assets and cryptocurrency wallet seed phrases within electronic art as recited in claim 22, further comprising:
a means to move the cryptocurrency within the game wallet to any other cryptocurrency wallet or exchange so it is not accessible to other players move cryptocurrency from game wallet, for the moving of the cryptocurrency in the game wallet to another cryptocurrency wallet or exchange so it is no longer available to any other player that may also set up a game wallet and guess the correct treasure wallet seed phrases.

24. A system and method for digital crypto treasure hunt using cryptographically secured assets and cryptocurrency wallet seed phrases within electronic art for to provide a cryptographically secured asset or assets for sale and resale that provide clues within the electronic artwork to a cryptocurrency treasure wallet seed phrases to provide a means for a user to access the treasure wallet as a means to win a digital cryptocurrency treasure hunt, comprising:
a means to create cryptocurrency wallets, means to create NFTs, means to move cryptocurrency between cryptocurrency wallets and NFT marketplace owner(s)/creator(s), for a person or persons responsible for the creation of various cryptocurrency wallets, electronic art, NFTs, as well as the interaction between cryptocurrency wallets and NFT marketplace for marketing, sale, and dissemination of funds between various cryptocurrency wallets;
a means to own cryptocurrency wallet, means to use a cryptocurrency wallet to interact with NFT marketplace to buy NFTs, means to determine treasure cryptocurrency wallet seed phrases by using clues in the NFT player, for a person or persons who would participate in the digital crypto hunting game through the purchase of NFTs) from NFT marketplace to determine seed phrases of the treasure wallet(s), and the creation of game wallet to enter treasure wallet seed phrases guesses into the game wallet to access the treasure wallet cryptocurrency;
a means to interact with cryptocurrency exchanges to obtain cryptocurrency, means to transfer cryptocurrency to pay NFT marketplace fees, means to accept transfers of cryptocurrency from NFT smart contract or NFT marketplace owner/creator wallet(s), for obtaining cryptocurrency from cryptocurrency exchanges to transfer to NFT marketplace for various fees and for receiving cryptocurrency from the sale of NFTs;
a means to obtain seed phrases to be used within creation of electronic art to give clues as to the words and order of the seed phrases, means to receive a portion of the cryptocurrency proceeds for the sale or resale of the electronic art sold as an NFT, means to allow access to any or all of the cryptocurrency proceeds for players that are able to determine the correct words and order of the seed phrases within another game wallet treasure wallet(s), for the creation of seed phrases in wallet setup to be used to generate clues within the creation of electronic art to be sold as an NFT, to accept a portion of the cryptocurrency proceeds for the sale and resale of the NFT and to allow access to any or all of the cryptocurrency sent to this wallet for the player who determines the correct seed phrase, including the correct spelling, number and order of placement of the seed phrases;
a means to generate a list of unique words, typically 12 to 24, set in a specific order upon creation of the cryptocurrency wallet, that allows access to the cryptocurrency associated with the wallet and transactions on the blockchain, otherwise known as seed phrases or seed recovery phrases, means where seed phrases can be entered in at the creation of cryptocurrency wallets to gain access to the cryptocurrency and transactions on the blockchain that are associated with that unique set of seed phrases generate seed phrases, for creation of treasure wallet seed phrases for the incorporation of these seed phrases into electronic art as clues to the nature of the word, number of words, and the order of the words associated with the treasure wallet;
a means to send cryptocurrency to other cryptocurrency wallets, exchanges and NFT marketplaces, means to receive cryptocurrency from the resale of any previously owned NFTs, means to receive NFTs that have been purchased, if the player chooses to move from the NFT marketplace to the wallet, means to connect to NFT marketplaces to allow the setup of user accounts that then allow for the purchase and sale of NFTs player wallet(s), for the connection and access the NFT marketplace, transferring cryptocurrency for the purpose of buying and selling of NFTs, to receive any purchased NFTs or to receive proceeds from the resale of previously purchased NFTs;
a means to create digital electronic art that uses various sensory stimulation in the art, mainly visual and auditory, means to save art in some electronic or digital format that can be viewed or replicated on other electronic devices, means to save in a format that a crypto smart contract can be attached electronic art, for creation of electronic art with various electronic devices that incorporates clues within the artwork as to the treasure wallet's seed phrases that allow a player to determine, through careful study and analysis, the correct words, number of words, and order of the words that constitute the seed phrases of the treasure wallet;
a means where clues are incorporated within the electronic art and can be in any form determined by the owner/creator as to assisting the player in determine the words, number of words, and order of the words of the seed phrases of the treasure wallet(s), means where the clues to the seed phrases may be in one or multiple electronic art pieces incorporate seed phrases as clues, for incorporation of clues within the electronic art to allow a player to determine the exact words, number of words, and order of placement of the words that constitute the seed phrases of the treasure wallet;
a means for the sending and receiving of various cryptocurrencies, means to accept electronic art for the creation of NFTs, means for the creation of NFTs through minting or other processes, means for the setting up of accounts for the creation of NFTs from electronic art, means for accounts to purchase, sell and resell NFTs, means for the marketing of NFTs for sale or resale, means for the calling or distribution of proceeds after purchase, sale or resale of NFTs NFT marketplace, for setting up of user accounts for the sending and receiving of cryptocurrencies for the creation of NFTs from electronic art and the purchase, sale and resale of those NFTs, central location for the marketing of NFTs and for the calling or distribution of proceeds from the purchase, sale and resale of NFTs;
a means for the account creation ties NFT marketplace to a specific wallet to be used in various cryptocurrency and NFT transactions user account, for the setting up of a user account on the NFT marketplace to allow for a tie to a cryptocurrency wallet used in various cryptocurrency and NFT transactions, paying fees for marketing and sales, transfer of NFTs, transfer of proceeds from sales and resales to a cryptocurrency wallet, acceptance of cryptocurrency for purchases from a wallet, transfer of cryptocurrency for minting fees or fees for the creation of NFTs, and other marketplace functions and costs;
a means to obtain a unique blockchain identification associated with the electronic art and identified on the blockchain or distributed ledger, means for the sale and resale of the NFT, which triggers an attached smart contract with predefined parameters as to what to do with the proceeds of the sale or resale, means for the NFT identification on the blockchain to be allowed to be transferred within the blockchain to other cryptocurrency wallets, NFT marketplaces or cryptocurrency exchanges create NFTs, for turning the electronic art into a unique NFT by attaching a smart contract to the electronic art through crypto minting or other means to register it on the blockchain;
a means for listing of NFTs for various prices and types of cryptocurrencies market NFTs for sale, for marketing of NFTs for sale within the NFT marketplace to entice players to purchase the NFTs;
a means for the sale of the NFT to trigger a smart contract, which lists one or more cryptocurrencies wallet addresses as owner or creator of the NFT, means for the sale of the NFT to trigger a smart contract which may list, for multiple wallets, the percentage of funds to be distributed between the wallets, means for the sale of the NFT to trigger a smart contract that may allow the calling of sale proceeds to be deliver to one or more wallets sale of the NFT triggers a smart contract, for sale or resale of the NFT triggers the smart contract which would push or allow the calling of sale or resale proceeds to one or more cryptocurrency wallet;
a means to acquire an NFT, typically through purchasing the NFT in a NFT marketplace, to participate in the crypto treasure hunt acquire an NFT, for the acquisition of an NFT, typically by purchasing the NFT through an NFT marketplace, to allow a player to participate in the digital crypto treasure hunt;
a means to determine the treasure wallet seed phrases by careful examination of the NFT for clues that will help determine the correct words, number of words and order of words that make up the treasure wallet seed phrases clue search, for the determination of the treasure wallet seed phrases, through careful study and examination, using the NFT art, knowledge of past or present events, external references, and the like, to determine the exact words, number of words, and order of words that make up the treasure wallet seed phrases;
a means to tie the cryptocurrency within the treasure wallet to the newly created game wallet game wallet, for the creation of a game wallet to test the guesses of the treasure wallet seed phrases in the attempt to tie the game wallet to the same seed phrases of the treasure wallet;
a means to enter the guesses that would be the exact treasure wallet seed phrases, including the correct words, number of words, and order of words that make up the treasure wallet seed phrases game wallet set up, for the setup of the game wallet using the guesses for the treasure wallet seed phrases to gain access to the treasure wallet cryptocurrency;
a means to determine if the seed phrases entered into the game wallet are exactly the same as those for the treasure wallet seed phrases entered correctly, for the attempt to enter the guesses within the setup of the game wallet to determine if the guesses of the seed phrases match the treasure wallet seed phrases;
a means for the correct entry of the seed phrases that match exactly the treasure wallet seed phrases in the set up of the game wallet to gain access to any or all of the cryptocurrency within the treasure wallet as recorded on the blockchain access to treasure wallet cryptocurrency, for the way to access the treasure wallet cryptocurrency by entering correctly in the set up of the game wallet the treasure wallet seed phrases, including the correct words, number of words, and order of the words;
a means to move the cryptocurrency within the game wallet to any other cryptocurrency wallet or exchange so it is not accessible to other players move cryptocurrency from game wallet, for the moving of the cryptocurrency in the game wallet to another cryptocurrency wallet or exchange so it is no longer available to any other player that may also set up a game wallet and guess the correct treasure wallet seed phrases; and
a method to acquire NFTs used to guess the correct treasure wallet seed phrases which are used to set up a new game wallet that can access the treasure wallet cryptocurrency example method, for the acquisition of NFTs that a player would use to guess the correct treasure wallet seed phrases which are further used to set up a new game wallet that, if the seed phrases guessed and entered in the setup, match the treasure wallet seed phrases, will allow a player to access the treasure wallet cryptocurrency through the game wallet.
